(19) United States
(12) Patent Application Publication
(10) Pub. No.: US 2014/0272247 A1
(43) Pub. Date: Sep. 18, 2014

(54) RIBBED BALSA

(71) Applicant: Milwaukee Composites, Inc., Cudahy, WI (US)

(72) Inventors: Brian R. Latz, Cedarburg, WI (US); James E. Desing, Elkhorn, WI (US)

(73) Assignee: Milwaukee Composites, Inc., Cudahy, WI (US)

(21) Appl. No.: 14/213,694

(22) Filed: Mar. 14, 2014

Related U.S. Application Data
(60) Provisional application No. 61/793,711, filed on Mar. 15, 2013.

(51) Int. Cl. E04C 1/40; B32B 38/18; B32B 38/00

(52) U.S. Cl. CPC E04C 1/40; B32B 38/0004; B32B 38/1816
USPC 428/58; 156/250

(57) ABSTRACT

A ribbed balsa sheet including a plurality of end-grain balsa strips arranged side-by-side to define a sheet plane, with the balsa grain oriented perpendicular to the sheet plane, and a number of reinforced resin ribs, each one of the reinforced resin ribs being arranged between an adjacent pair of the balsa strips to bond together and space apart the balsa strips.

### CROSS REFERENCE TO RELATED APPLICATIONS

This application claims priority to Provisional Application No. 61/793,711, which was filed on Mar. 15, 2013. The entire contents of the provisional application are hereby incorporated by reference herein.

### BACKGROUND

The present invention relates to manufactured balsa products, for example, for use in a lightweight composite panel. Such balsa products, and panels containing such balsa products, have a wide range of use, including flooring and wall panels. The panels may be used in mass transit conveyances, among other places.

Typically, a balsa core for a composite panel is sourced as an end-grain sheet (FIG. 1), including a plurality of individual end grain blocks B bonded directly together side-by-side, bonded with such adhesives as polyvinyl acetate and other thermal setting adhesives. The grain directions G for each and every one of the blocks B are parallel to each other (Z direction), perpendicular to the sheet plane (X-Y direction). The end grain balsa sheets provide good compression strength and impact resistance at low weight, but are not particularly stiff.

### SUMMARY

In one embodiment, the invention provides a ribbed balsa sheet including a plurality of end-grain balsa strips arranged side-by-side to define a sheet plane, with the balsa grain oriented perpendicular to the sheet plane, and a number of reinforced resin ribs, each one of the reinforced resin ribs being arranged between an adjacent pair of the balsa strips to bond together and space apart the balsa strips.

In another embodiment the invention provides a composite panel including a core having a ribbed balsa sheet having a plurality of reinforced resin ribreinforced reinforced resin ribs, and first and second resin skins sandwiching the core on upper and lower end grain surfaces thereof. Each of the reinforced resin ribs bonded to both the first and second resin skins such that the first and second resin skins are bonded through the balsa sheet via the reinforced resin ribs.

In yet another embodiment, the invention provides a method of manufacturing a ribbed balsa sheet. The method including stacking a plurality of cross-grain balsa sheets atop one another with a resin layer between each adjacent pair of sheets, all of the cross-grain balsa sheets defining parallel sheet planes, curing the resin layers to bond the plurality of cross-grain balsa sheets into a multi-layer cross-grain stack, and cutting the stack perpendicular to the sheet planes into a plurality of end grain balsa sheets, each having a plurality of end-grain balsa strips separated by reinforced resin ribs.

In yet another embodiment, the invention provides a method of manufacturing a composite panel. The method includes manufacturing a ribbed balsa sheet including a plurality of reinforced resin ribs, sandwiching the ribbed balsa sheet between a first resin skin adjacent a first end-grain side of the ribbed balsa sheet and a second resin skin adjacent a second end-grain side of the ribbed balsa sheet, and bonding the first and second resin skins together through the reinforced resin ribs of the ribbed balsa sheet.

Other aspects of the invention will become apparent by consideration of the detailed description and accompanying drawings.

### BRIEF DESCRIPTION OF THE DRAWINGS

FIG. 1 is a perspective view of a conventional end grain balsa sheet.

FIG. 2 is a perspective view of a panel of multiple cross-grain balsa sheets, according to one aspect of the invention.

FIG. 3 is a perspective view of a ribbed balsa sheet, cut from the panel of FIG. 2.

FIG. 4 is a perspective view of a multi-sheet panel similar to that of FIG. 2.

FIG. 5 is an end view of the multi-sheet panel of FIG. 4.

FIG. 6 is a front view of the multi-sheet panel of FIG. 4.

FIG. 7 is an end view of the multi-sheet panel of FIG. 4.

FIG. 8 is a schematic view of a composite panel including the ribbed balsa sheet.

FIG. 9 is a cross-sectional view of the composite panel taken along line 9-9 of FIG. 8.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

FIG. 2 illustrates a panel 20 constructed from a plurality of balsa sheets 24. Each of the balsa sheets 24 defines a length L and a width W that is perpendicular to the length L. The length L and the width W define a sheet plane. Typically, the length L and the width W are the two largest sheet dimensions. In a direction transverse to the plane, the panel 20 defines a thickness T, and each of the sheets 24 defines an individual sheet thickness T₁, T₂, T₃. Although three sheets 24 make up the panel 20 in FIG. 2, there may be two or more than three sheets 24 within the panel 20.

Each of the sheets 24 is a cross-grain sheet, or non-end-grain sheet. In other words, the grain of the balsa sticks 28 that make up the sheet 24 run cross-wise on the sheet plane, rather than in the direction of the sheet thickness (end-grain sheet). The balsa sticks 28 can be bonded to adjacent balsa stick or sticks within the same sheet 24 with polyvinyl acetate. The grain direction is indicated by the two-headed arrow G. Because balsa wood has much higher strength in the grain direction G than in the transverse direction, the sheets 24 are individually very flimsy.

However, the sheets 24 are stacked on top of each other with interstitial high-strength bonding layers 32. For example a resin layer may be provided between each adjacent balsa sheet 24, separating the sheets 24 from directly contacting each other, but forming a high strength bond therebetween. The resin layer can be of any reasonable type and any reasonable thickness, which may be manipulated to meet design constraints for a particular application. Examples of some suitable resin materials for the bonding layers 32 include phenolic, polyester, epoxy, vinyl ester, urethane, and all other thermoset resins. A catalyst may be used to chemically transform and solidify the resin. It should be noted that the thickness of the bonding layers 32 and/or the sheet thickness T₁, T₂, T₃ may be varied as desired within the panel 20. In addition to the resin, the bonding layers 32 can include reinforcement material therein.

The reinforcement material can be glass, and can be provided as a fiber (e.g., fiberglass strands or sheet laid into the resin). For example, the reinforcement material can be fiberglass cloth, fiberglass chopped strand mat, fiberglass knitted fabric, or fiberglass roving. Other reinforcement materials can include glass, aramid, carbon, graphite, or other thermoset or thermoplastic monofilament among others. Similar to fiberglass, these other materials could also be oriented as cloth, chopped strand mat, knitted fabric, or roving. In addition, the cloth, chopped strand mat, fiberglass knitted fabric, and fiberglass roving could be hybridized and included more than one type of reinforcement material.

In addition, the orientation of the glass fiber strands of the reinforced material can vary such that the strands may extend mainly in one direction (parallel to or perpendicular to the width direction W of the panel shown in FIG. 2) or any direction in between. In addition, multiple layers of this material may be placed on top of each other to define filament angulations of 90 degrees relative to each other, or in other arrangements may define any filamentary angulation between and including 0 and 90 degrees. Alternatively, the strands of the reinforcement material can be oriented in two perpendicular directions (e.g., biaxial fiberglass roving). When the biaxial fiberglass roving is used, it can be oriented such that the strands are aligned with (or offset from) the length L and width W directions of the panel shown in FIG. 2. In other constructions, multiple layers of the same or different reinforcement materials can be used in a single bonding layer.

Once the desired quantity of balsa sheets 24 are stacked together with the bonding layers 32 therebetween, the resin of the bonding layers 32 is cured to solidify the sheets of the panel 20 together. This may include a timed exposure to pressure and/or heat. The resin of the bonding layers 32 may penetrate the balsa. Once cured, the panel 20 is cut along a cut line 36 that is transverse to the sheet plane and transverse to the grain direction G. In the illustrated construction, the cut line 36 is along the length direction, as the grain runs in the width direction. The cut is made to a desired width W′. As shown in FIG. 3, the portion cut from the panel 20 defines a ribbed, end-grain balsa sheet 40, in which the cut width W′ defines the thickness of the sheet 40. In other words, when cut from the panel 20, the ribbed sheet 40 is rotated 90 degrees on its lengthwise edge to define a new sheet plane, perpendicular to the original sheet plane. This not only orients the grain direction G transverse to the sheet plane for maximum strength, but also orients the bonding layers 32 into the same orientation, so that the bonding layers 32 form ribs extending through the end-grain sheet 40 from one face to the other. Once cut to form the ribbed sheet 40, what was each individual sheet 24 forms a lengthwise strip 24′ of the ribbed sheet 40. Likewise, the individual balsa sticks 28, which extended across the width W of the sheets 24, are trimmed to individual blocks 28′ within each strip 24′.

FIGS. 4-7 illustrate another balsa panel 20, which corresponds to the above described panel, but is constructed of six cross-grain balsa sheets 24, and five interstitial resin bonding layers 32. As best illustrated in FIG. 7, the outermost sheets 24 have thicknesses T₁, T₆, that are substantially equal to each other and substantially less than the thicknesses T₂, T₃, T₄, T₅ of the inner sheets 24. The methodology to produce the panel 20, cut the panel 20, and form the ribbed balsa sheet 40 is carried out as described above. The panel 20 of FIGS. 4-7 produces a ribbed sheet 40 of six side-by-side end-grain strips 24′, separated by five reinforced resin ribs 32. As noted in FIG. 7, the rib quantity, spacing, and thickness may be varied on a project-specific basis. Although not shown, the rib portions extending out beyond the strips 24′ may be trimmed off for final use.

As mentioned in the Background section above, FIG. 1 illustrates an end-grain balsa sheet having a sheet plane defined by a length X and a width Y, and having a transverse thickness Z. Although the grain direction G is parallel with the thickness Z for good compression strength and impact resistance, the structural rigidity of the non-ribbed sheet of FIG. 1 is drastically lower than what is possible with a ribbed sheet 40 described above. Although the ribbed sheet 40 may have a slightly higher overall weight due to high density of the reinforced resin ribs 32, the arrangement (material, size, spacing, etc.) can be optimized to take advantage of the light weight of the balsa while providing bending strength beyond what is possible with a similar non-ribbed balsa sheet.

Although the ribbed sheets 40 described above can prove useful in a variety of standalone applications, they may also be used within a composite panel 100 (FIGS. 8 and 9), as a core of the panel. The composite panel 100 may take a form similar to that described in any of prior Milwaukee Composites, Inc. U.S. Pat. Nos. 6,824,851, 7,897,235, and 8,329,278, the entire contents of which are incorporated by reference herein. For example, the composite panel 100 can include upper and lower skins 104, 108, and peripheral closeouts 112, such as phenolic blocks. The upper skin 104 is removed from FIG. 8 to expose the ribbed sheet 40 used as a core. The ribbed sheet 40 may be used throughout the composite panel 100, or in only a specified area, which requires additional strength. For example, the composite panel 100 of FIG. 8 is shown with three designated areas A, B, C, and the ribbed sheet 40 is only provided in area C. The other areas A and B can be provided with a lower weight alternative (e.g., non-ribbed balsa, foam, etc.) to keep the overall panel weight down. The ribs 32 within the sheet 40 can form respective bonds with the upper and lower skins 104, 108 to further enhance the strength of the panel 100. In fact, the use of the ribbed balsa sheet 40 as a core within the composite panel 100, even in a limited area, may enable the thickness of the skin(s) 104, 108 to be reduced, to limit overall weight and cost.

In addition to flooring or wall panels for mass transit conveyances, ribbed balsa sheets can be used in:
Yacht and ship keels, main beam support spars and center sills for stiffening marine, land transportation structures, elevator walls, and floor structures;
Stiffening core members for additional lamination by processors into composite structures;
Internal core materials used to stiffen and improve wind turbine spars and wind turbine blades; and
Structural building support members as interior core profiles molded within composite structures employing such composite manufacturing processes as pultrusion, vacuum bag, resin-infusion, hand lay-up, resin transfer and/or filament winding.

1. A ribbed balsa sheet comprising:
a plurality of end-grain balsa strips arranged side-by-side to define a sheet plane, with the balsa grain oriented perpendicular to the sheet plane; and
a number of reinforced resin ribs, each one of the reinforced resin ribs being arranged between an adjacent pair of the balsa strips to bond together and space apart the balsa strips.

2. The ribbed balsa sheet of claim 1, wherein each of the plurality of balsa strips and each of the reinforced resin ribs extends an entire length of the balsa sheet.

3. The ribbed balsa sheet of claim 2, wherein each of the reinforced resin ribs includes reinforcing glass material therein.

4. The ribbed balsa sheet of claim 3, wherein each of the reinforced resin ribs includes phenolic resin.

5. A composite panel comprising:
a core including a ribbed balsa sheet having a plurality of reinforced resin ribs; and
first and second resin skins sandwiching the core on upper and lower end grain surfaces thereof, each of the reinforced resin ribs being bonded to both the first and second resin skins such that the first and second resin skins are bonded through the balsa sheet via the reinforced resin ribs.

6. The composite panel of claim 5, wherein the ribbed balsa sheet is provided as the only core material throughout the panel.

7. The composite panel of claim 5, wherein the ribbed balsa sheet is provided throughout less than the entire core of the panel, the panel including a second, dissimilar core material.

8. A method of manufacturing a ribbed balsa sheet, the method comprising:
stacking a plurality of cross-grain balsa sheets atop one another with a resin layer between each adjacent pair of sheets, all of the cross-grain balsa sheets defining parallel sheet planes;
curing the resin layers to bond the plurality of cross-grain balsa sheets into a multi-layer cross-grain stack; and
cutting the stack perpendicular to the sheet planes into a plurality of end grain balsa sheets, each having a plurality of end-grain balsa strips separated by reinforced resin ribs.

9. The method of claim 8, wherein the plurality of cross-grain balsa sheets all have a common thickness.

10. The method of claim 8, wherein the plurality of cross-grain balsa sheets include at least two sheets of different thicknesses.

11. A method of manufacturing a composite panel, the method comprising:
manufacturing a ribbed balsa sheet including a plurality of reinforced resin ribs;
sandwiching the ribbed balsa sheet between a first resin skin adjacent a first end-grain side of the ribbed balsa sheet and a second resin skin adjacent a second end-grain side of the ribbed balsa sheet; and
bonding the first and second resin skins together through the reinforced resin ribs of the ribbed balsa sheet.

12. The method of claim 11, further comprising providing a second, dissimilar core material between the first and second resin skins, alongside the ribbed balsa sheet.

13. The method of claim 11, further comprising providing the ribbed balsa sheet as the only core material throughout the panel.
